(19) United States
(12) Patent Application Publication
(10) Pub. No.: US 2011/0019002 A1
(43) Pub. Date: Jan. 27, 2011

(54) Method and System for Low Complexity Analysis of Multiple Signals Using a Combined Sparse Set of Samples

(75) Inventors: Ashish Jagmohan, Yorktown Heights, NY (US); Vadim Sheinin, Yorktown Heights, NY (US)

Correspondence Address: F. CHAU & ASSOCIATES, LLC;Frank Chau, 130 WOODBURY ROAD, WOODBURY, NY, 11797, US

(73) Assignee: International Business Machines Corporation, Armonk, NY (US)

(21) Appl. No.: 12/507,571

(22) Filed: Jul. 22, 2009

(51) Int. Cl. H04N 7/18; G06K 9/00

(52) U.S. Cl. 348/159; 382/107; 348/E07.086

(57) ABSTRACT

A method of and system for signal analysis includes acquiring multiple signals from the environment by using multiple sensor elements, applying a transform which combines the multiple acquired signals into a single combined signal, and reduces the number of samples in the combined signal, applying a single signal analysis and event detection operation on the resultant combined, sparse signal, and performing a complete signal analysis using multiple analysis elements for the multiple input signals only in the case where the sparse signal analysis indicates that the event of interest may be present.

### BACKGROUND

1. Technical Field

The present invention is related generally to signal analysis, and more particularly to low-complexity signal analysis wherein analysis complexity is reduced by obtaining a sparse, combined set of samples from the multiple signals.

2. Discussion of Related Art

Referring to FIG. 1, a sensor network including N sensor nodes and N signal analysis elements. The elements sensor 1 100, sensor 2 101, to sensor N 102 are the N sensor elements which are acquiring signal data from the environment to be analyzed. For example, the N sensor element may be video cameras acquiring light intensity signal data from a real-world environment. Each sensor is paired with a corresponding signal analysis element, which processes the signal captured by the corresponding sensor, in order to perform, for example, event detection. Thus signal 1 analysis element 110 analyzes the signal acquired by sensor element 100, signal 2 analysis element 111 analyzes the signal acquired by sensor element 101, and signal N analysis element 112 analyzes the signal acquired by sensor element 102. The outputs of the signal analysis elements, 110 to 112 are input to an event detector 130 which processes these further, in order to determine whether an event of interest occurred. The detector output 131 signals the detection of the event. For example, the output 131 may be binary with the value 1 signifying that the event was detected, and the value 0 signifying that the event was not detected.

FIG. 2 shows a system for motion detection in video surveillance network, according to FIG. 1. The sensors include the N video cameras 200 to 202, which capture light intensity and color signal data samples from the environment under surveillance. The system detects a motion event; in case such an event is detected the system should output a motion alarm as well as the index of the camera on which motion was detected. To accomplish this, the output of each camera is input into a corresponding motion estimation element. Thus, for example, the video signal acquired by camera 200 is input to the motion estimation element 210, the video signal acquired by camera 201 is input to the motion estimation element 211, and the video signal acquired by camera 202 is input to the motion estimation element 212. The motion estimation elements 210 to 212 compute an estimate of the magnitude of motion in each video signal. In the case where there is no motion, each motion estimation element will detect at most a small amount of motion caused by intensity/color noise in the signal acquired by the cameras, as well as small changes in the lighting conditions of the environment being imaged. The motion estimate signals computed by elements 210 to 212 are input to the motion threshold alarm element 230. Element 230 compares each motion estimate signal to a predetermined threshold. If any estimate signal exceeds the threshold, element 230 activates the motion alarm line 231, and outputs the index of the motion signal for which the threshold was exceeded on the camera index line 232.

The conventional system for signal analysis described above uses multiple signal analysis elements to analyze the obtained signals. A drawback of this type of technique is the large computational complexity of analyzing each of multiple signals separately using a different analysis element. This computation is especially wasteful in the case where the event being looked for happens only infrequently. One class of methods attempt to reduce the complexity of signal analysis by acquiring a sparse set of samples from which the original signals can be reconstructed. Examples of this class of methods are described in Patent No. US20080080773, U.S. Pat. No. 7,345,603, Patent No. WO2007050593, and U.S. Pat. No. 7,289,049. One drawback of this class of methods is that the signal has to be reconstructed prior to analysis, and multiple analysis elements are still needed for signal analysis. Another method for low complexity signal analysis is described in US20060241916. The described method does not enable low-complexity analysis by combining multiple signals. It only allows simple signal classification and does not enable general signal analysis (such as motion detection for video surveillance, data hiding analysis for images etc).

Therefore, a need exists for an improved method for low-complexity analysis of multiple signals, in the case that the event to be detected from analysis happens infrequently, by reducing the number of samples and the number of signal analysis elements.

### BRIEF SUMMARY

According to an embodiment of the present disclosure, a video surveillance device includes a plurality of cameras, a combining transform module combining multiple signals output from the plurality of cameras into a single sparse signal, a motion estimation module receiving the single sparse signal and outputting an event detection signal, and a complete analysis module receiving the multiple signals and the event detection signal from the motion estimation module.

According to an embodiment of the present disclosure, a method of signal analysis includes acquiring multiple signals from an environment using multiple sensor elements, applying a transform, by a processor, combining the multiple signals into a combined signal and reducing a number of samples in the combined signal, applying a single signal analysis and event detection operation, by the processor, on the combined signal having a reduced number of samples, and performing a complete signal analysis, by the processor, using multiple analysis elements for the multiple signals in a case where the event detection operation detects an event.

According to an embodiment of the present disclosure, in a video surveillance device comprising a computer readable medium embodying instructions executed by a processor to perform a method for motion detection, the method includes acquiring multiple input signals from a plurality of cameras, applying an additive transform which generates a single video signal from the multiple input signals, wherein the single video signal has fewer samples than in the multiple input signals, applying a single motion estimation analysis and an event detection operation to the single video signal, and performing a complete motion estimation analysis using a multiple motion estimation analysis of the multiple input signals in the case where the event detection operation detects an event of interest.

### BRIEF DESCRIPTION OF THE SEVERAL VIEWS OF THE DRAWINGS

Exemplary embodiments of the present disclosure will be described below in more detail, with reference to the accompanying drawings:

FIG. 1 is a sensor network with N sensors and N analysis elements;

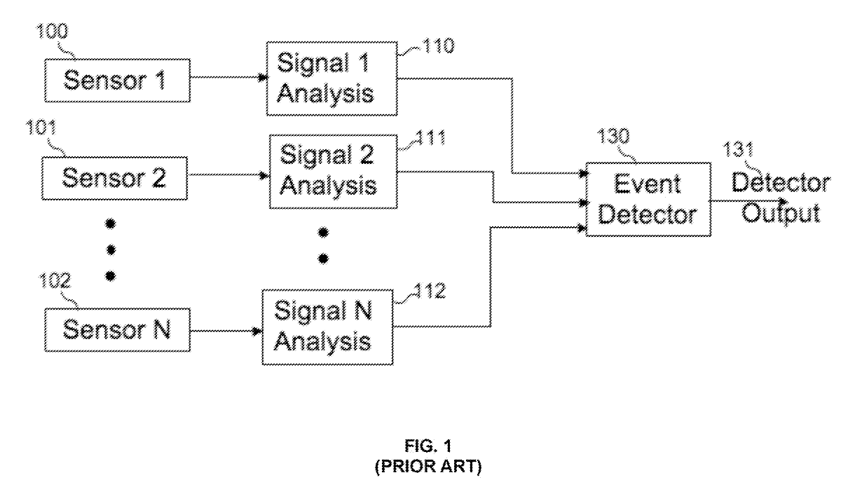

FIG. 2 is a flow chart of motion detection in a video surveillance network according to FIG. 1

FIG. 3 is a network with N sensor nodes, a combining transform and a combined, sparse analysis node according to an embodiment of the present disclosure;

FIG. 4 is a system for motion detection from a video surveillance network according to FIG. 3; and

FIG. 5 is a diagram of a computer system for implementing a method for low complexity signal analysis according to an embodiment of the present disclosure.

### DETAILED DESCRIPTION

According to an embodiment of the present disclosure, methods and systems for low-complexity analysis of multiple signals are described. Low-complexity analysis of multiple signals is performed in the case when an event of interest is not occurring, by obtaining a sparse, combined set of samples from the multiple signals.

According to an embodiment of the present disclosure, a method of signal analysis includes acquiring multiple signals from the environment by using multiple sensor elements, applying a transform which combines the multiple acquired signals into a single combined signal, and reduces the number of samples in the combined signal, applying a single signal analysis and event detection operation on the resultant combined, sparse signal, and performing a complete signal analysis using multiple analysis elements for the multiple input signals only in the case where the combined signal analysis indicates that the event of interest may be present.

According to an embodiment of the present disclosure, a video surveillance device detects motion events. The low-complexity motion detection analysis acquires multiple input signals (e.g., video signals) from a plurality of cameras, applies an additive transform which generates a single video signal from the multiple input signals, such that the generated video signal has fewer samples than those in the input signals, that is, the single video signal is sparse in comparison of the multiple input signals, applies a single motion estimation analysis to the resultant combined video signal, and performs a complete motion estimation analysis using multiple motion estimation analysis elements for the multiple input signals only in the case where the combined analysis indicates that the event of interest may be present.

According to an embodiment of the present disclosure, the computationally intensive complete analysis of the multiple signals is performed in the case that the combined motion estimation signal analysis detects that motion may be present. Thus, low-complexity combined analysis is performed in other cases, e.g., when motion is not present, enabling computational savings over the conventional solution.

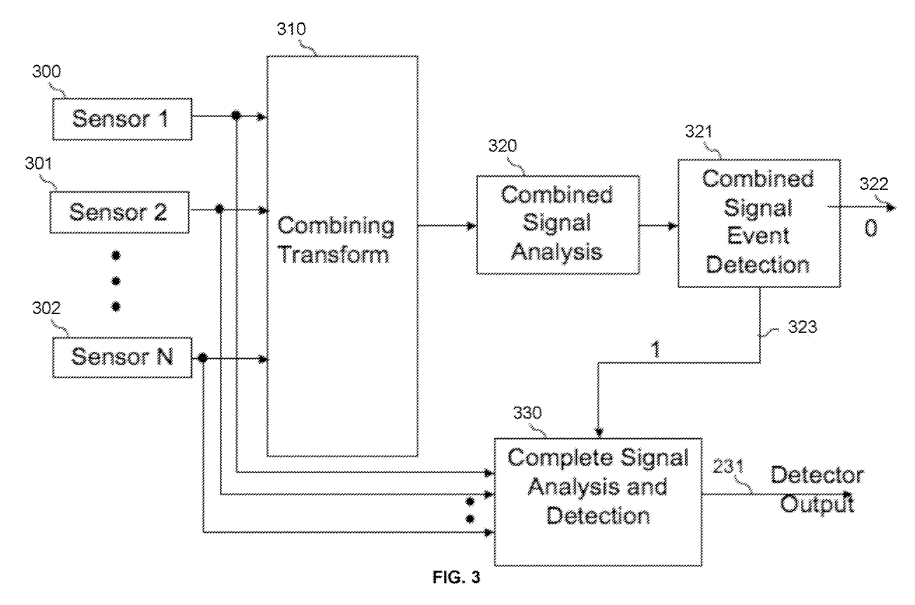

FIG. 3 shows an exemplary embodiment of the present disclosure. The N sensor elements 300, 301 to 302 acquire N signals from the environment being monitored. The signals acquired may be video/image intensity signals for a surveillance network, or may be other quantities such as computer network traffic measurements etc. The signals acquired by the N sensor elements are input to the transform element 310, which combines the signals into one signal, which has a number of samples which is only 1/N of the total number of samples from the signals acquired by the N sensors 300 to 302. The transform element may additionally further reduce the number of elements through downsampling.

The single combined signal output by the transform element 310 is input to the combined signal analysis element 320. Signal analysis typically requires a level of computational complexity that increases monotonically with an increasing number of signal samples. Since the combined signal analysis element 320 processes only the combined, sparse set of signal samples, its computational complexity is lower than performing signal analysis over all the samples of all N acquired signals. The signal analysis element 320 outputs a set of features extracted from the combined signal. These features are input to the combined signal event detector element 321, which determines if the event of interest has occurred. If the event is not detected, the output 0 line 322 is set active. If the event is detected, the output 1 line 323 is activated. The activation of line 323 activates the complete signal analysis element 330. Element 330 performs complete signal analysis and event detection from the N signals acquired by sensors 300 to 302, using N signal analysis elements. This result of this analysis and detection process is output on line 331. The complete signal analysis element 330 requires a computational complexity equal to that required for analysis in the conventional system. However, it is activated only when the combined signal analysis element 320 detects the possibility of occurrence of the event of interest. For events that occur infrequently element 330 would only rarely be activated.

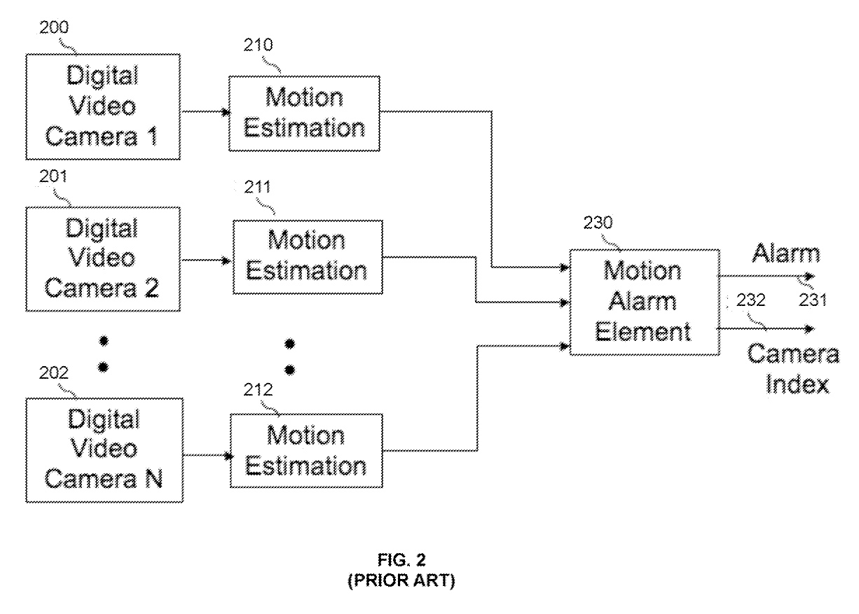

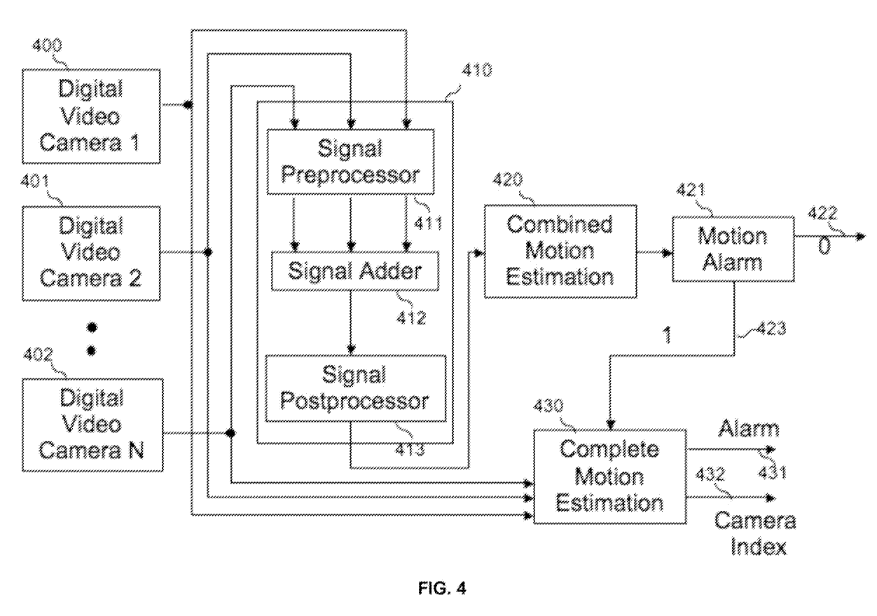

FIG. 4 shows an exemplary embodiment of a low-complexity system for motion detection from a video surveillance network according to FIG. 2. The sensors include the N digital video cameras 400 to 402, which capture light intensity and color signal data samples from the environment under surveillance. The system detects a motion event; in case such an event is detected the system should output a motion alarm as well as the index of the camera on which motion was detected. Further, it is desired that the complexity of the signal analysis be low when the motion events to be detected occur infrequently.

The N video signals acquired by the cameras 400 to 402 are input to the additive combining transform element 410. The additive transform element first performs preprocessing of the intensities of the video signals through element 411, in order to minimize data loss during combining. In an exemplary embodiment, the preprocessing element 411 downscales the histogram of each video signal, thereby reducing the dynamic range of each signal. In the next step the N preprocessed video signals are input to the element 412 which adds the signals together. The output of the element 412 is a single video signal with samples which are, in number, 1/N of the total number of samples input to the combining transform element 410. Next the combined video signal is input to the post-processing element 413, which re-adjusts the intensities of the combined signal in order to facilitate more accurate analysis on the combined signal and/or lower-complexity analysis of the combined signal. In an exemplary embodiment, the post-processing element 413 performs histogram scaling and equalization on the combined signal. In an additional embodiment the post-processing element 413 performs down-sampling in addition to histogram scaling, in order to further reduce the number of samples which need to be analyzed. In an additional embodiment, the element 413 performs down-sampling on the basis of a simple low-complexity initial motion estimate. In an exemplary embodiment the said initial motion estimate is formed by performing a simple intensity/color frame difference of spatially corresponding pixels from the current combined frame and the temporally previous combined frame, with pixels having difference below a threshold being discarded.

The output of the post-processing element 413 is a single combined video signal with a small number of samples. This is input to the combined motion estimation element 420. Element 420 computes an estimate of the magnitude of motion in the combined video signal. In an exemplary embodiment element 420 uses a block-based search, wherein for each block of pixels in the current frame the best matching block in a previous frame is sought. In this embodiment, the magnitude of motion is quantified by the difference in the relative positions of the current and previous frame blocks, and by the magnitude of the intensity and color difference between the two blocks. In the usual case where there is no motion in any of the original N video signals, the motion estimation element will detect at most a small amount of motion in the combined signal caused by intensity/color noise and lighting condition changes. Further, since the block-based search has computational complexity which grows linearly with the number of samples, the reduction of samples achieved by means of element 410 considerably reduces the complexity of motion estimation analysis.

The motion estimates computed by elements 410 are input to the motion threshold alarm element 421. In an exemplary embodiment, element 421 compares the motion position magnitude and the intensity difference magnitude for each block to predetermined thresholds. Based on the number of these that exceed the corresponding thresholds, element 421 determines whether motion may be present. If motion is not detected, the output 0 line 422 is set active. If the event is detected, the output 1 line 423 is activated.

The activation of line 423 activates the complete motion estimation analysis element 430. Element 430 includes N motion estimation elements, each of which is applied to one of the N video signals acquired by the cameras 400 to 402. In an exemplary embodiment each motion estimation element in element 430 uses a block-based search, wherein for each block of pixels in the current frame the best matching block in a previous frame is sought. The magnitude of motion is quantified by the difference in the relative positions of the current and previous frame blocks, and by the magnitude of the intensity and color difference between the two blocks. The computed motion position magnitudes and the intensity difference magnitudes for each individual video signal are compared to predefined thresholds. Based on these, the element 430 determines if motion is present, and if so, the index of the video signal in which the motion is present. In an exemplary embodiment the predefined thresholds for element 430 are set to a lower value than the corresponding thresholds for element 421, such that the motion estimation criteria are stricter for the complete analysis element 430. The results of the motion detection are output on the motion alarm line 431 and the camera index line 432.

Exemplary embodiments of the present disclosure can be extended to systems where the acquired signal samples represent spatially and temporally separated signals which need to be probed for infrequent events such as error conditions in computer networks.

It is to be understood that embodiments of the present disclosure may be implemented in various forms of hardware, software, firmware, special purpose processors, or a combination thereof. In one embodiment, a method for low complexity signal analysis may be implemented in software as an application program tangibly embodied on a computer readable medium. The application program may be uploaded to, and executed by, a processor comprising any suitable architecture.

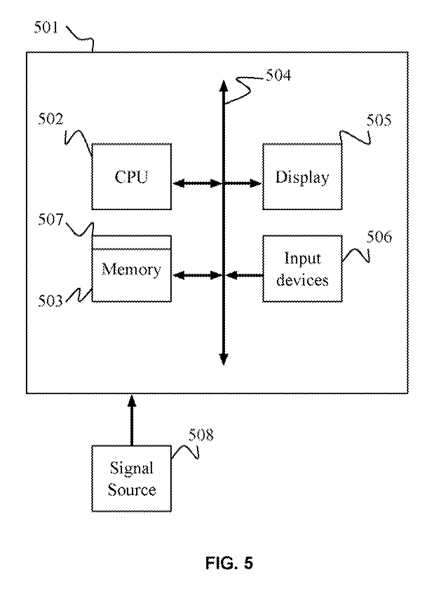

Referring to FIG. 5, according to an embodiment of the present disclosure, a computer system 501 for implementing a method for low complexity signal analysis can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present invention.

The computer platform 501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method of low complexity signal analysis using a sparse set of samples, it is noted that modifications and variations can be made by persons skilled in the art in light of the above teachings. It is therefore to be understood that changes may be made in exemplary embodiments of disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A video surveillance device comprising:
a plurality of cameras;
a combining transform module combining multiple signals output from the plurality of cameras into a single sparse signal;
a motion estimation module receiving the single sparse signal and outputting an event detection signal; and
a complete analysis module receiving the multiple signals and the event detection signal from the motion estimation module.

2. The video surveillance device of claim 1, wherein the combining transform module sums the multiple signals to obtain a combined single sparse signal.

3. The video surveillance device of claim 2, wherein the transform module includes a preprocessor, which performs at least one of scaling intensity and color range, and intensity and color filtering of one or more of the multiple signals, prior to the summing the signals.

4. The video surveillance device of claim 2, wherein the transform module includes a postprocessor, which performs at least one of histogram scaling and equalization and downsampling of the combined single sparse signal obtained by the said summing.

5. The video surveillance device of claim 1, wherein motion estimation is performed by the motion estimation module on the single sparse signal.

6. The video surveillance device of claim 5, wherein the event detection signal is activated by the motion estimation module when the motion detected exceeds a threshold, the motion determined by differences in the relative positions of signal blocks, and by intensity and color changes in the signal.

7. The video surveillance device of claim 1, wherein the complete analysis module is in a power down mode when the event detection signal is not activated.

8. The video surveillance device of claim 1, wherein upon receiving the event detection signal the complete analysis module determines if a motion event has been detected, and determines an index of a camera which sighted motion.

9. The video surveillance device of claim 8, wherein the complete analysis module comprises multiple motion estimation modules, with each module performing motion estimation on a signal received from one of the plurality of cameras, and the index of a camera which detected motion is determined by the magnitude of motion detected in the signal acquired by the camera.

10. A method of signal analysis comprising:
acquiring multiple signals from an environment using multiple sensor elements;
applying a transform, by a processor, combining the multiple signals into a combined signal and reducing a number of samples in the combined signal;
applying a single signal analysis and event detection operation, by the processor, on the combined having a reduced number of samples; and
performing a complete signal analysis, by the processor, using multiple analysis elements for the multiple signals in a case where the event detection operation detects an event.

11. The method in claim 10, wherein the environment is a computer network comprising multiple distributed compute elements, wherein the event to be detected is at least one of excess computer traffic over a network link, and a link or compute element error in the network, wherein the sensor elements are monitoring elements attached to the network, the multiple signals are numeric traffic and error monitoring signals, and the transform is an additive combination of filtered traffic and the error monitoring signals.

12. The method of claim 10, wherein a computer readable medium embodies instructions executed by the processor to perform the method of signal analysis.

13. The method of claim 10, wherein event of interest is motion greater than a threshold.

14. In a video surveillance device comprising a computer readable medium embodying instructions executed by a processor to perform a method for motion detection, the method comprises:
acquiring multiple input signals from a plurality of cameras;
applying an additive transform which generates a single video signal from the multiple input signals, wherein the single video signal has fewer samples than in the multiple input signals;
applying a single motion estimation analysis and an event detection operation to the single video signal; and
performing a complete motion estimation analysis using a multiple motion estimation analysis of the multiple input signals in the case where the event detection operation detects an event of interest.

15. The video surveillance device of claim 14, wherein event of interest is motion greater than a threshold.
